(19) United States
(12) Patent Application Publication
(10) Pub. No.: US 2008/0232310 A1
(43) Pub. Date: Sep. 25, 2008

(54) FLEXIBLE USER EQUIPMENT-SPECIFIED DISCONTINUOUS RECEPTION

(76) Inventor: Shugong Xu, Vancouver, MA (US)

Correspondence Address: MICHAEL BLAINE BROOKS, PC, P.O. BOX 1630, SIMI VALLEY, CA, 93062-1630, US

(21) Appl. No.: 11/761,252

(22) Filed: Jun. 11, 2007

Related U.S. Application Data
(60) Provisional application No. 60/895,655, filed on Mar. 19, 2007.

(51) Int. Cl. H04Q 7/28

(52) U.S. Cl. 370/329

(57) ABSTRACT

The embodiments of the present invention provide for methods, devices, and systems adapted to enable an eNodeB and a user equipment (UE) to negotiate a set of discontinuous reception (DRX) parameters, as well as enable an eNodeB to instruct a UE to directly apply a certain DRX level or period from the negotiated set of DRX parameters, via Layer 3 signaling, Layer 2 in-band signaling, and/or L1/L2 signaling.

### CROSS-REFERENCE TO RELATED APPLICATIONS

This application claims the benefit of U.S. Provisional Patent Application Ser. No. 60/895,655 filed Mar. 19, 2007, entitled “Method and System of Flexible User Equipment-Specified Discontinuous Reception,” which is hereby incorporated by reference herein for all purposes. This application is also related to co-pending application with U.S. patent application Ser. No. 11/684,934 filed Mar. 12, 2007, entitled “Explicit Layer Two Signaling For Discontinuous Reception.”

### FIELD OF THE INVENTION

The embodiments of the present invention relate to discontinuous reception (DRX), particularly to DRX in Evolved Universal Terrestrial Radio Access Network (E-UTRAN) and Long Term Evolution (LTE).

### BACKGROUND

The 3rd Generation Partnership Project, also referred to as “3GPP,” is a collaboration agreement that aims to define globally applicable Technical Specifications and Technical Reports for 3rd Generation Systems. 3GPP Long Term Evolution (LTE) is the name given to a project to improve the Universal Mobile Telecommunications System (UMTS) mobile phone or device standard to cope with future requirements. Although termed 3GPP, the 3GPP may define specification for the next generation mobile networks, systems, and devices. In one aspect, UMTS has been modified to provide support and specification for the Evolved Universal Terrestrial Radio Access (E-UTRA) and Evolved Universal Terrestrial Radio Access Network (E-UTRAN). A technical specification for the E-UTRA and E-UTRAN may be found in the 3GPP website, www.3gpp.org, e.g., in the TS 36.300 document.

Mobile devices are common nowadays. Such devices typically require power, such as from a battery, to run. Considering that the typical battery life is limited, ways of efficiently utilizing this limited resource, as well as providing good user experience are desirable. In defining the specification, one of the goals of E-UTRA and E-UTRAN is to provide power-saving possibilities on the side of the user device, whether such device is in the idle or active mode. In one aspect, power-saving means are provided by discontinuous reception (DRX) schemes. Ways of providing power-saving means are thus desirable, particularly using DRX schemes.

### SUMMARY

In one aspect, a method of managing a user equipment (UE) by an eNodeB is provided. The method includes the steps of transmitting, via a Layer 3 signaling, by said UE to said eNodeB, a set of one or more DRX parameters; defining, by said eNodeB, a UE-specific set of DRX parameters based on said received set of one of more DRX parameters from said UE; receiving by said UE said UE-specific set of DRX parameters; transmitting, by said eNodeB to said UE, a current DRX indicator associated with a DRX parameter to apply from said UE-specific set of DRX parameters; and directly applying by said UE said indicated DRX parameter.

In another embodiment, a system, including an eNodeB and a UE operably connected to said eNodeB, is provided. The eNodeB includes a DRX controller and negotiator module and a communication interface module. The DRX controller and negotiator module is adapted to receive, via a Layer 3 signaling, from a user equipment (UE) a set of one or more DRX parameters; define a UE-specific set of DRX parameters based on said received set of one of more DRX parameters from said UE; transmit said UE-specific set of DRX parameters; and transmit a current DRX indicator associated with a DRX parameter to apply from said UE-specific set of DRX parameters. The communication interface module of the eNodeB is adapted to enable communication between said UE and said eNodeB. The UE, on the other hand, includes a DRX execution and negotiator module and a communication interface module. The DRX execution and negotiator module is adapted to transmit, via said Layer 3 signaling, said set of one or more DRX parameters; receive said UE-specific set of DRX parameters; receive said current DRX indicator associated with said DRX parameter to apply from said UE-specific set of DRX parameters; and directly apply said DRX parameter for discontinuous reception. The communication interface module of the UE is adapted to enable communication between said UE and said eNodeB.

In another aspect, an eNodeB device is provided. The device includes a DRX controller and negotiator module and a communication interface module. The DRX controller and negotiator module is adapted to receive, via a Layer 3 signaling, from a user equipment (UE) a set of one or more DRX parameters; define a UE-specific set of DRX parameters based on said received set of one of more DRX parameters from said UE; transmit said UE-specific set of DRX parameters; and transmit a current DRX indicator associated with a DRX parameter to apply from said UE-specific set of DRX parameters. The communication interface module of the eNodeB is adapted to enable communication between said UE and said eNodeB.

In another aspect, a method of discontinuous reception (DRX) processing at a user equipment (UE) is provided. The method includes receiving, by said UE, a UE-specific set of DRX parameters; receiving, by said UE, at least one explicit signaling to trigger transition of said UE from a continuous reception DRX level to a first DRX level from said UE-specific set of DRX parameters, wherein said first DRX level has a longer period than said continuous reception DRX level; directly applying, by said UE, said first DRX level; expiring of a timer; and directly applying, by said UE, a second DRX level from said UE-specific set of DRX parameters, wherein said second DRX level has a longer period than said first DRX level.

### BRIEF DESCRIPTION OF THE DRAWINGS

The present invention is illustrated by way of example and not limitation in the figures of the accompanying drawings, and in which:

FIGS. 1 and 2 are graphs of prior art DRX control mechanisms;

FIG. 3 is a high-level block diagram of an exemplary radio communication system, according to an embodiment of the invention;

FIG. 4 is a high-level block diagram of exemplary control protocol stacks of a station, such as an eNodeB, and a user equipment (UE), according to an embodiment of the invention;

FIG. 5 is a high-level block diagram of exemplary signals or messages that may be transmitted between an eNodeB and a UE to configure the UE to directly apply a particular DRX parameter from a UE-specific set of DRX parameters, according to an embodiment of the invention;

FIG. 6 is another high-level block diagram of exemplary signals or messages that may be transmitted between an eNodeB and one or more UEs, according to an embodiment of the invention;

FIG. 7 is a diagram of exemplary discontinuous reception (DRX) fields and their associated definitions, according to embodiments of the invention;

FIG. 8 is another diagram of other exemplary DRX fields and their associated definitions, according to embodiments of the invention;

FIG. 9 is an exemplary graph applying the flexible and UE-specific DRX control mechanism, according to an embodiment of the invention;

FIG. 10 is a block diagram of an exemplary eNodeB station, according to an embodiment of the invention; and

FIG. 11 is a block diagram of an exemplary UE device, according to an embodiment of the invention.

### DETAILED DESCRIPTION

Discontinuous reception (DRX) generally is a method of providing means to conserve battery power, particularly of mobile devices. In general, the process of DRX includes having a user equipment (UE) and the network, for example, negotiate phases or intervals in which data transfer may occur. During other times, the receiver of the UE is typically turned off thereby entering into a low-power state and conserving battery resources.

The Evolved Universal Terrestrial Radio Access Network (E-UTRAN) and Evolved Universal Terrestrial Radio Access (E-UTRA) specifications recommend that a client device or user equipment (UE) in E-UTRAN active mode supports the following: (1) fast throughput between the network and the UE, (2) good power-saving schemes on the UE side, and (3) the synchronization of the network and the UE DRX intervals. The fast throughput may be supported, for example, by providing for short DRX periods, whenever possible. By having short DRX periods, the receiver is more likely to be turned on more often thereby enabling data transfers more frequently. Power saving schemes, however may also be supported by applying long DRX periods, whenever possible. A longer DRX period typically relates to a longer length of time in which a receiver is turned off thereby conserving battery. The specifications thus recommend flexible DRX periods. Furthermore, in supporting this flexibility, the specifications recommend a DRX scheme or mechanism that ensures that the setting and/or changing of DRX parameters is performed in such a manner that enables network and UE DRX synchronization to be maintained at all times.

In the current LTE working assumption, discontinuous reception (DRX) is controlled by the E-UTRAN based on a set of DRX parameters, which predefines the levels or periods of DRX which may be applied by the user equipments (UEs). The set of DRX levels/periods, however, are the same for all the UEs. For example, in the “Meeting Minutes RAN2 #56 bis (January 2007)”, it stated the following: “DRX values can go from continuous reception up to e.g., 5.12s by increment of a factor (closed to) 2 (detailed value to be considered e.g. 1, 2, 5, 10, 20, etc). Values to use are controlled by the Nw.” Nw stands for network.

Considering that the LTE project considers current, evolving, and future network systems, it is reasonable to expect that network traffic patterns, the functions and capabilities, including battery capacity, of UEs in these network systems, and the Quality of Service (QoS) requirements to be diversified, and more so diversified in the future. For example, some UEs may be expected to only receive a portion of the possible applications traffic. Some UEs, for example, may have only multimedia broadcast and multicast service (MBMS) capability and thus have a different UE requirement as compared to other UEs. Other UEs may also require higher data rates for the type of data being transferred. Furthermore, other UEs may not need to apply DRX, considering that such UEs are not running on battery, e.g., a notebook computer being powered via a charger, or the UE is running out of battery. Thus, in many scenarios, UEs may not need so many levels of unified DRX value(s). Furthermore, a UE may function more efficiently with a specified set of DRX parameters tailored to that specific UE. For example, some UE may function better with having only two levels of DRX parameters, e.g., 0 ms for “No DRX” and 5.12 sec for the longest DRX permitted by the network. The current working assumption of LTE is currently not flexible to handle the needs of various UEs in the network, considering that the current specification generally requires the same set of DRX levels/periods for all the UEs in the network. Multimedia services are generally services that handle several types of media, such as audio and video in a typically synchronized way from the user's point of view. A multimedia service may involve multiple parties, multiple connections, and the addition or deletion of resources and users within a single communication session. A multicast service, on the other hand, is typically a unidirectional point-to-multipoint (PTM) service in which a message may be transmitted from a single source entity to all subscribers currently located within a geographical area. The message may contain a group identifier indicating whether the message is of interest to all subscribers or to only the subset of subscribers belonging to a specific multicast group.

The embodiments of the present invention relate to discontinuous reception (DRX), particularly those applied within the Evolved Universal Terrestrial Radio Access (E-UTRA) and Evolved Universal Terrestrial Radio Access Network (E-UTRAN), particularly providing a UE-specific set of DRX parameters to each UE. Although described in relation to E-UTRA and E-UTRAN, the embodiments of the present invention may apply to other networks, wired or wireless, and to other specifications or standards, including those that may later be developed.

In general, a DRX parameter may include or relate to a number of DRX information, including when a UE may go to sleep and for how long. A DRX cycle length or DRX period, for example, is generally the time distance between the start positions of two consecutive active periods. An active period is the period during when a UE's transmitter and/or receiver is turned on, while a sleep period is the period during which a UE's transmitter and/or receiver is turned off, thereby saving power. Described in another way, the set of DRX parameters enables a UE to go to sleep and just be periodically awake or active to receive incoming data.

E-UTRA and E-UTRAN provide for packet-based systems adapted to support both real-time and conversational class traffic. The embodiments of the present invention provide for systems, devices, and methods adapted to have UEs within a network managed by an eNodeB in E-UTRA and E-UTRAN to have UE-specific set of DRX parameters. The embodiments of the present invention may apply to 3GPP LTE. One of ordinary skill in the art having the benefit of this disclosure, however, will appreciate that the devices, systems, and procedures described herein, may also be applied to other applications.

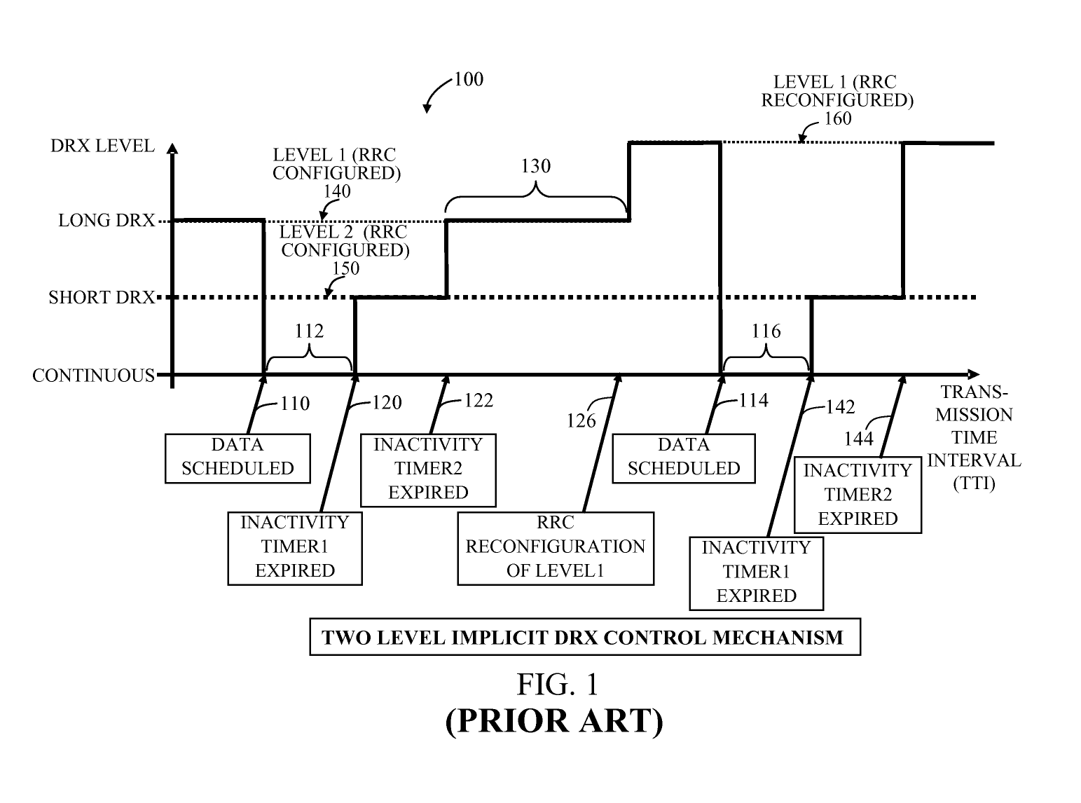

FIGS. 1 and 2 are exemplary graphs related to two prior art DRX control mechanisms where FIG. 1 illustrates a graph 100 showing the DRX levels/periods for a two-level implicit DRX control mechanism and where FIG. 2 illustrates a graph 200 showing the DRX levels/periods for an explicit any-level DRX control mechanism. As may be seen in FIGS. 1 and 2, the only case when the DRX level is reduced is when a “Data scheduled” event 110, 114, 210, 214 occurs. When that event 110, 114, 210, 214 occurs, the DRX level is always forced to a “continuous” level 112, 116, 212, 216, which means no DRX, typically identified with having the DRX level/period being set to 0 (zero) ms. Such feature as shown is not very flexible.

Furthermore, as shown, a UE may not go directly to a desired DRX level. For example, as shown in FIG. 1, a UE has to undergo two timer expirations, i.e., expiration of Timer 1 120 and expiration of Timer 2 122, before the UE is able to apply a long DRX period 130, i.e., in this example is Level 1 DRX. In general, the implicit configuration of this example is via timers. Configuration may also be performed via Radio Resource Control (RRC) configuration or signaling 126. In this graph, Timer 1 expiration 120 made the UE apply—from continuous DRX level, i.e., no DRX—to a short DRX 150, i.e., Level 2 DRX, while expiration of Timer 2 122 lead to the application of the long DRX level 140, i.e., Level 1 DRX 140. During the transmission time interval (TTI), an RRC signaling 126 also configured/reconfigured the Level 1 DRX 140 to a new longer DRX level 160, i.e., a new Level 1 DRX. Thus, at the expiration of Timer 1 142, the short DRX level-Level 2 DRX—is applied, and at the expiration of Timer 2 144, after RRC reconfiguration of Level 1 126, leads to the UE applying the now reconfigured or the new Level 1 DRX or the long DRX interval 160. In general, the expiration of Timer 1 triggers the UE to apply from a continuous reception DRX to a short DRX, and the expiration of Timer 2 triggers the UE to apply from a short DRX level to the long DRX level. FIG. 1 thus shows, that in some cases, the current DRX control mechanism forces a UE to unnecessarily consume more power. The DRX levels, level 1 and 2, in this exemplary embodiment, have been configured via a Layer 3 protocol, particularly by the Radio Resource Control (RRC) layer 140, 150.

Furthermore, although FIG. 2 utilizes explicit signaling 220, 222, 224, 226, 228, this explicit signaling mechanism is still not very flexible. The explicit signaling mechanism of FIG. 2 includes a DRX indicator in the last media access control (MAC) protocol data unit (PDU) that is delivered to the UE. This indicator, which is typically one bit, notifies the UE that the eNodeB currently has no data for the UE and the UE may go into sleep mode using a second level DRX parameter. This explicit signaling of FIG. 2 is still not flexible, because the explicit signaling mechanism does not explicitly indicate to the UE which particular DRX level/period or parameter to apply. This indicator typically just indicates whether the UE is to go to sleep or not. Although it seems that the exemplary graph 200 shows that explicit signaling provides for the UE to go to a higher DRX level, it does not indicate which particular higher level to apply.

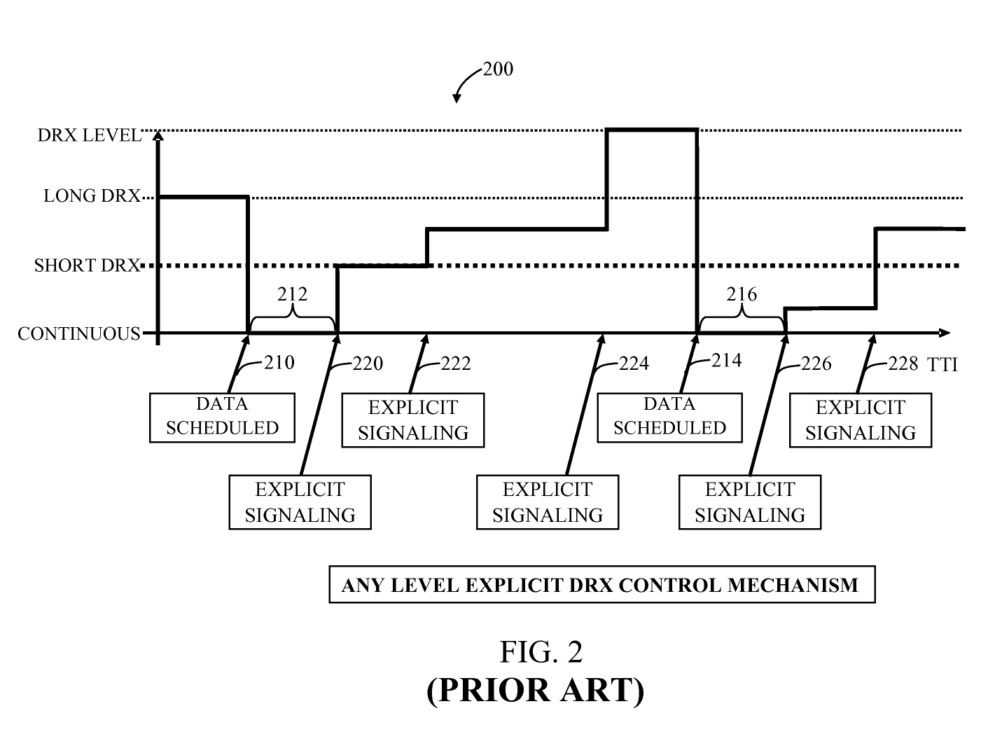

FIG. 3 is an exemplary diagram of a mobile and/or radio communication system 300, according to an embodiment of the invention. This exemplary system 300 is an exemplary E-UTRAN. An E-UTRAN may consist of one or more base stations, typically referred to as eNodeBs, or eNBs, 352, 356, 358, providing the E-UTRA user-plane and control-plane protocol terminations towards the UE. An eNodeB is an E-UTRAN device responsible for: radio transmission in a cell to the User Equipment and/or radio reception in the cell from the User Equipment. In general, an eNodeB handles the actual communication across the radio interface, covering a specific geographical area, where the specific geographical area may also be referred to as a cell. Depending on sectoring, one or more cells may be served by an eNodeB, and accordingly the eNodeB may support one or more mobile user equipments (UEs) depending on where the UEs are located.

An eNodeB 352, 356, 358 may perform several functions, which may include but are not limited to, radio resource management, radio bearer control, radio admission control, connection mobility control, dynamic resource allocation or scheduling, and/or scheduling and transmission of paging messages and broadcast information. An eNodeB 352, 356, 358 may also be adapted to determine and/or define the set of DRX parameters, including the initial set, for each UE managed by that eNodeB, as well as transmit such DRX parameters. The eNodeBs of the present invention are also adapted to negotiate with UEs that are adapted to have a personalized set of DRX parameters. In this example, if the UEs 304, 308, 312 managed by the leftmost eNodeB 352 are all adapted to have a personalized set of DRX parameters, that eNodeB negotiates with each of those UEs, thereby enabling such UEs 304, 308, 312 to have UE-specific sets of DRX parameters.

In this exemplary system 300, there are three eNodeBs 352, 356, 358. The first eNodeB 352 manages, including providing service and connections to, three UEs 304, 308, 312.

Another eNodeB 358 manages two UEs 318, 322. Examples of UEs include mobile phones, personal digital assistants (PDAs), computers, and other devices that are adapted to communicate with this mobile communication system.

The eNBs 352, 356, 358 of the present invention may communicate 342, 346, 348 with each other, via an X2 interface, as defined within 3GPP. Each eNodeB may also communicate with a Mobile Management Entity (MME) and/or a System Architecture Evolution (SAE) Gateway, not shown. The communication between an MME/SAE Gateway and an eNodeB is via an S1 interface, as defined within the Evolved Packet Core specification within 3GPP.

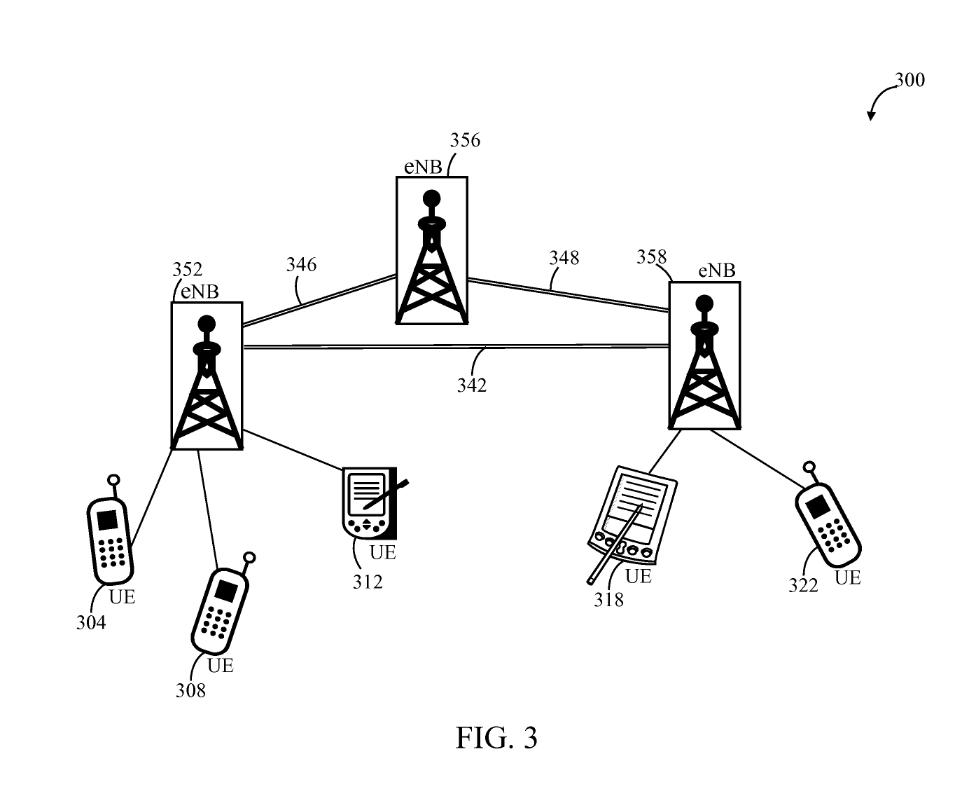

FIG. 4 is an exemplary diagram 400 of a portion of the protocol stack for the control plane of an exemplary UE 440 and an exemplary eNodeB 410. The exemplary protocol stacks provide a radio interface architecture between an eNodeB 410 and a UE 440. The control plane, in general, includes a Layer 1 stack consisting of a physical PHY layer 420, 430, a Layer 2 stack consisting of a medium access control (MAC) 418, 428 layer, and a Radio Link Control (RLC) layer 416, 426, and a Layer 3 stack consisting of a Radio Resource Control (RRC) layer 414, 424. There is another layer referred to as a Packet Data Convergence Protocol (PDCP) layer in E-UTRA and E-UTRAN, not shown. The inclusion of the PDCP layer in the control plane is still being decided by 3GPP. The PDCP layer is likely to be deemed a Layer 2 protocol stack.

The RRC layer 414, 424 is generally a Layer 3 radio interface adapted to provide information transfer service. Information provided by the RRC layer may include system information. Furthermore, the RRC layer may establish, maintain, and release an RRC connection between the UE and the E-UTRAN. In particular, the RRC layer of the present invention also transfers or communicates a set of DRX parameters from the eNodeB 410 to the UE 440, as well as provides RRC connection management. Depending on the capability of the UE, the set of DRX parameters may be a UE-specific set or a generalized one. The DRX period being applied by a UE is typically associated with a discontinuous transmission (DTX) period at the eNodeB side to ensure that data are transmitted by the eNodeB and received by the UE at the appropriate time periods. The RRC layer also performs other services and functions.

The RLC 416, 426 is a Layer 2 radio interface adapted to provide transparent, unacknowledged, and acknowledged data transfer service, while the MAC layer 418, 428 is a radio interface layer providing unacknowledged data transfer service on the logical channels and access to transport channels. The MAC layer 418, 428 is also typically adapted to provide mappings between logical channels and transport channels.

The PHY layer 420, 430 generally provides information transfer services to MAC 418, 428 and other higher layers 416, 414, 426, 424. Typically the PHY layer transport services are described by their manner of transport. Furthermore, the PHY layer 420, 430 is typically adapted to provide multiple control channels. The UE 440 is adapted to monitor this set of control channels. Furthermore, as shown, each layer communicates with its compatible layer 444, 448, 452, 456. The specifications, including the conventional functions of each layer, may be found in the 3GPP website, www.3gpp.org.

The embodiments of the present invention provide for a flexible DRX mechanism, which provides a UE-specific set of DRX levels or parameters and a process for such control mechanism. The UE-specific set of DRX parameters, are tailored to the UE capability and its application. Furthermore, the DRX control mechanism of the present invention enables flexible adjustment of the DRX level/period or parameter using, for example, Layer 2 explicit signaling, in such a way that an eNodeB is adapted to instruct the UE to apply a desired DRX level/period or parameter directly and faster.

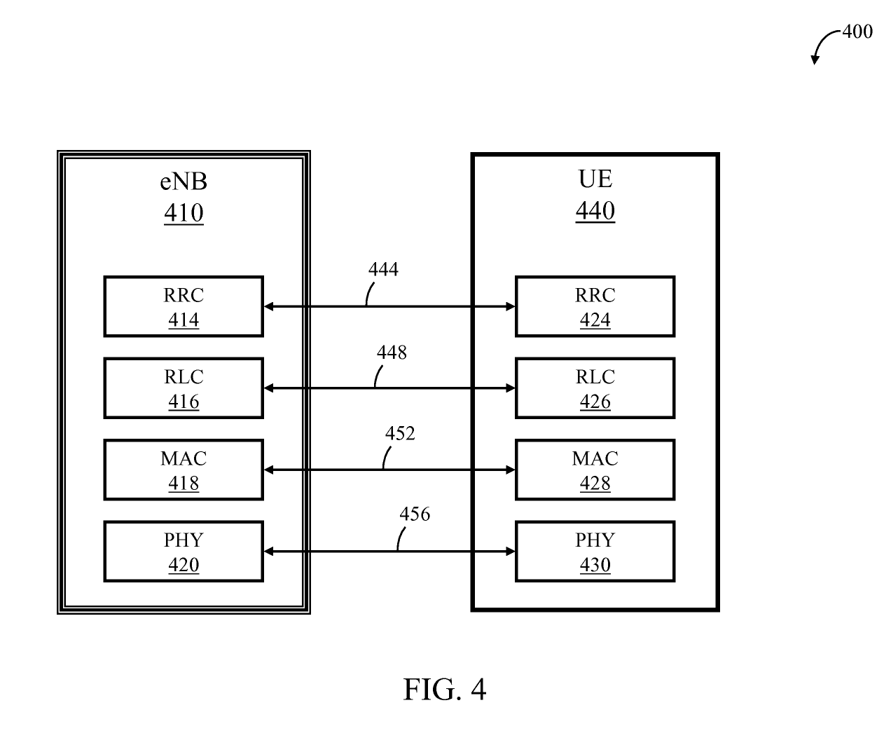

FIG. 5 is a high-level block diagram 500 illustrating at a high-level, signals or messages that may be exchanged between an eNodeB 410 and a UE 440 to enable a UE to have a UE-specific set of DRX parameters.

Generally, an eNodeB 410 configures the possible set of UE DRX levels/periods of a UE 440 via RRC signaling or other higher layer protocol stacks based on various conditions, such as, but not limited to, the traffic pattern in the network and/or of the UE and the QoS requirements of applications received by the UE. In general, both the UE 440 and the eNodeB 410 are aware of the set of possible DRX levels via a signaling or negotiation process. Such configuration or negotiation may happen when new traffic is added or removed in the network. Such negotiation may also occur when the battery capability of the UE has significantly changed, for example, when the UE is using a charger, or the UE is running short of battery.

In some embodiments, a UE 440 adapted to have a personalized or UE-specific set of DRX levels informs the network, particularly the eNodeB 410 that the UE is adapted to have a personalized set of DRX levels 5 10. As part of such communication, the UE may include a set of DRX parameters that the UE wishes to be configured or applied. Once the network, particularly the eNodeB 410, receives such a message or communication 510, the eNodeB or the network (NW) may start a signaling or negotiation process 512 to negotiate with that UE so as to determine or define the UE-specific set of DRX parameters for that UE, which may be based on the received set of DRX parameters suggested by the UE. In some embodiments, the negotiation process 512 may indicate to the eNodeB 410 that the UE may be configured for a UE-specific set of DRX levels, without explicitly sending a separate communication indicating that the UE is configured for a UE-specific set of DRX levels. In other embodiments, other information, such as parameters, associated with DRX levels/periods may also be exchanged or negotiated between the eNodeB and the UE 440. The UE 440 and/or the eNodeB 410 may use RRC 414, 424 or a higher-layer signaling process to negotiate the set of DRX levels/periods, including indicating to the eNodeB that the UE is a customizable UE.

In some embodiments, the UE-specific set of DRX parameters may be adjusted or may be renegotiated at any time, once that UE 440 is attached to the network via the eNodeB. In some embodiments, the UE-specific set may be a set of DRX levels/periods as defined, for example, in the “Meeting minutes RAN2 #56bis (January 2007).” Based on the current LTE working assumption discussed in the “Meeting minutes RAN2 #56bis (January 2007),” the potential standard DRX levels or periods may include the following (in ms): 1, 2, 5, 10, 20, 50, 100, 200, 500, 1000, 2000, 4000, 5120, etc. In other embodiments, the UE-specific set of DRX parameters are those that are outside or different from such suggested levels.

To illustrate a UE-specific DRX control mechanism, let us assume that a UE 440 negotiates with an LTE network typically via an eNodeB 410 to have the following DRX parameters—2 ms, 20 ms, 100 ms, and 1500 ms. The UE 440 thus indicates that it 440 does not want to apply or be in the 1 ms, 5 ms, 10 ms, . . . levels/periods. The UE also wishes to wake up, e.g., have its receiver on, at least once per 1500 ms (1.5s) due to its special application. Note that in this exemplary embodiment, 2 ms, 20 ms, 100 ms are standard DRX levels, but 1500 ms is not. By requesting its UE-specific set of parameters, the UE may have less and better tailored DRX levels/periods.

Another example where a UE-specific set of levels/periods may be helpful is when a UE 440 is now using a charger as its source of power. In this embodiment, the UE may choose to inform the network, via the eNodeB 410, that it does not need to go to sleep frequently. By informing the eNodeB of this condition, the eNodeB is thereby able to schedule a downlink transmission to this UE with better QoS, and without having the eNodeB determining or worrying whether such UE is in the sleep mode.

Based on this UE-specific DRX embodiments, an exemplary flexible DRX control mechanism process may include the following:
1. A set of possible DRX levels/periods or parameters that are defined and/or negotiated between the UE and the network, via an eNodeB. Such a UE-specific set is typically tailored for that UE. The set may include various UE-specific DRX levels/periods or parameters, for example.
2. An eNodeB may configure the UE DRX levels via RRC signaling. The UE DRX levels may be based on the traffic pattern in the network or for that particular UE, the QoS requirement for such UE, and other factors. Both the eNodeB and the UE are typically aware of the set of DRX levels, for example, via storing such information in a data store, such as a memory. Furthermore, the UE-specific set of DRX parameters may be updated typically at any time, e.g., via RRC signaling. The UE-specific set of DRX parameters may be updated, for example, when new traffic to the UE is added or removed. In other embodiments, the UE-specific set of DRX parameters may be updated when the UE's battery capability is significantly changed, for example, when the UE is utilizing a charger rather than a battery source or the UE is running short of battery.
3. The scheduling information in the L1/L2 control channel for the UE indicates the coming downlink transmission, which the UE should be awake for or have the receiver on to receive such a transmission. Such signaling, however, does not typically inform which DRX level or parameter is to be applied by the UE. (The E-UTRA and E-UTRAN support control signaling via L1/L2 control channel, via MAC control protocol data unit (PDU), and RRC control signaling.) L1/L2, in general, is a term used in the 3GPP specification, indicating a means of communicating information, particularly control information, between L1 (Layer 1) and/or L2 (Layer 2) layers of the two communication end-in our case, an eNodeB and a UE. In general, this means of communication is understood by both eNodeB and the UE, such that information may be exchanged. For example, an eNodeB and the UE are aware of the structure of the data and where in such data structure the appropriate control information is to be read. Similarly, this information exchanged, as well as the manner of exchanging such information, is understood by the appropriate layers, i.e., Layer 1 and Layer 2. In some embodiments, the L1/L2 control channel may refer to one or a few resource blocks that may be read by the appropriate entity, such as by the eNodeB and the UE, so as to receive information, such as control information.
4. Layer 2 signaling may also be applied to explicitly adjust the DRX levels/periods or parameters, particularly to adjust which DRX parameter from the set of DRX parameters the UE is to apply 550. Generally, the DRX parameter to be applied by a UE may be transmitted via in-band signaling, which is via Layer 2 data units or protocol data units. The indication of which DRX parameter to be applied may be contained as part of the header format, be part of the payload, and/or both. Such Layer 2 in-band signaling mechanism is disclosed herein and also disclosed in the U.S. patent application Ser. No. 11/684,934, entitled “EXPLICIT LAYER TWO SIGNALING FOR DISCONTINUOUS RECEPTION,” filed on Mar. 12, 2007, from the same inventor of this application. In other embodiments, the L1/L2 control signaling channel may be used to explicitly indicate the exact DRX level. The L1/L2 control channel is disclosed in the E-UTRA and E-UTRAN specifications. Thus, in some embodiments, an eNodeB may instruct a UE to apply the desired DRX level directly, and the UE applying the desired level faster. In some embodiments, where there is no downlink data or transmission to piggyback the Layer 2 control signaling, automatic implicit transition to a longer DRX level or period may also be performed. Such logic may be configured with the UE, for example. In other embodiments, the DRX indicator to adjust the DRX level to apply is via Layer 3 signaling, e.g., RRC signaling.
5. At any time, the UE typically stays in one active DRX level or period, which is one of the levels/periods in the set of DRX parameters for that specific UE.

### Layer 2 In-band Signaling

In some embodiments, the set of DRX parameters, particularly the levels/periods, to be applied by a UE may be transmitted via in-band signaling, which is via Layer 2 data units or protocol data units (PDU). Layer 2 in-band signaling is different from L1/L2 signaling. The indication of which DRX parameter to be applied, the DRX indicator, may be contained as part of the header format, be part of the payload, and/or both. In one preferred embodiment, MAC PDU is used for Layer 2 in-band signaling.

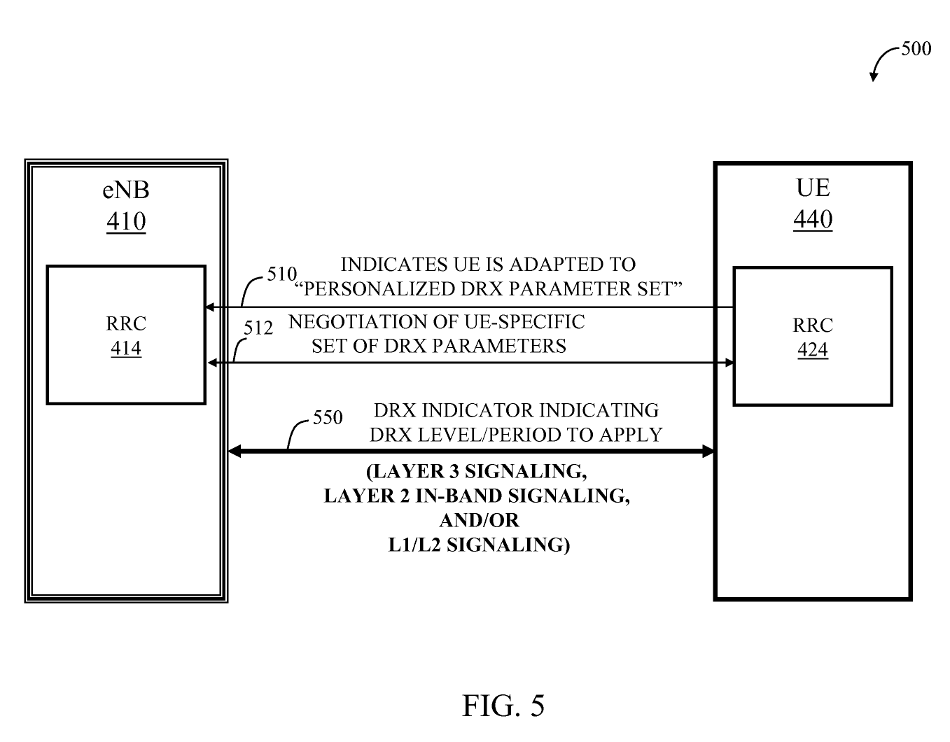

FIG. 6 is a block diagram 600 showing an exemplary system and the exemplary manners in which a UE 620, 630 may receive and/or negotiate DRX parameters from the eNodeB 610, according to an embodiment of the invention. In this exemplary embodiment, the eNodeB 610 manages two UEs 620, 630. The DRX controller module 650 is a functional block diagram of the eNodeB 610 that typically determines, defines, and/or negotiates the set of DRX parameters to be applied by the UE and/or which DRX parameter, particularly DRX period/level, from such a set is to be applied by the UE. The determination of the set of DRX parameters may be based on the particular needs of the UE, as mentioned herein. Furthermore, the determination of which DRX parameter to instruct the UE to apply may be based on the 3GPP specification or based on other algorithms. Such determination by the eNodeB 610 may be, for example, based on the eNodeB downlink buffer status, network traffic pattern, UE activity level, radio bearer QoS requirements, network traffic volume, neighbor cell measurements information, and/or other conditions. Considering that the eNodeB hosts or performs the scheduling function, such a determination may provide good throughput, as well as a good battery-saving performance scheme. The DRX controller module 650 may be embodied as a set of program instructions—e.g., software, hardware—e.g., chips and circuits, or both—e.g., firmware.

The E-UTRA and E-UTRAN support control signaling via L1/L2 control channel, via MAC control protocol data unit (PDU), and RRC control signaling. In some embodiments, the particular DRX parameter, particularly the level/period, to apply by the UE, is communicated via in-band signaling 646, 656 via Layer 2 control protocol stack data units, such as via MAC PDUs, RLC data units, or possible PDCP data units. In general, however, only one type of Layer 2 protocol stack PDU is applied per communication system, to perform the in-band signaling features described herein. For example, if MAC PDUs are used for Layer 2 in-band signaling in System A, System A only uses MAC PDUs, i.e., it typically may not augment the Layer 2 in-band signaling of the present invention to adjust DRX parameters with RLC PDUs in System A. Thus, each system typically may use only one type of Layer 2 protocol stack PDU for in-band signaling. An unrelated communication system B, however, may use another type of Layer 2 protocol stack PDU, e.g., RLC PDU, for in-band signaling, but similarly, System B may typically use only that type of Layer 2 protocol stack PDU. A system, however, may use some or all types of Layer 2 PDUs in its system for various reasons and functions, so long as the system typically applies only one Layer 2 protocol stack type for in-band signaling of the present invention. The exemplary system in FIG. 6 600 shows Layer 2 in-band signaling using MAC PDUs and RRC signaling. L1/L2 signaling is not shown.

In some embodiments, L1/L2 signaling, not shown, may also be used to communicate the particular DRX parameter to be applied by the UE. The embodiments of the present invention augment RRC signaling of DRX parameters with Layer 2 in-band signaling or L1/L2 signaling of DRX parameters. Layer 3 signaling, in general, relates to the communication between a Layer 3 protocol stack of the eNodeB 410 to a corresponding compatible Layer 3 protocol stack of the UE 440. As mentioned, Layer 3 signaling although more reliable is typically slower than Layer 2 signaling. Layer 2 in-band signaling relates to communicating via Layer 2 PDUs.

In some embodiments, Layer 3 RRC signaling, from the eNodeB 610 to the UE 620, 630, provides an initial set of DRX parameters, which may have been negotiated between the eNodeB and the UE, to configure the UE, for example, upon connection to the network. This initial set of DRX parameters may be replaced by the eNodeB 610 via another RRC signaling 642, 652. The replacement set may also have been negotiated between the UE and the eNodeB. RRC signaling may also provide a current RRC DRX parameter, i.e., the DRX parameter to be applied by the UE, which may have been signaled by the RRC when a radio bearer was setup or based on a last RRC update, for example. This current RRC DRX parameter may be an initial default value. The DRX parameter to be applied may be transmitted by the eNodeB via in-band signaling, L1/L2 signaling, and/or RRC signaling. The set of DRX parameters received via RRC signaling thus provides or configures a set of DRX parameters from which the UE may be instructed to select the DRX parameter to be applied by the UE. RRC signaling may also be applied to explicitly change the current DRX parameter being applied, which may have been set or configured via a previous RRC signaling or in-band signaling. The set of DRX parameters may be changed by the eNodeB based on conditions and/or triggering events, e.g., new radio bearer connections, decline in QoS of one or more radio bearers, network traffic, and the like. Furthermore, considering that the set of DRX parameters 602, 660 is UE-specific and is typically negotiated between a UE 602, 630 and the eNodeB 610, the set of DRX parameters 620 for the first UE 602, UE1, may be different from the set of DRX parameters 660 for the second UE 630, UE2.

In general, each radio bearer for a UE has its own QoS requirement, e.g., Voice over Internet Protocol (VoIP), File Transfer Protocol (FTP), and instant messaging each have their own QoS requirements. Although a UE may be serviced by multiple radio bearers, the embodiments of the present invention provide for one set of DRX parameters and/or a DRX parameter to be applied by the UE, per UE and not per radio bearer. Described in another way, DRX parameters are typically defined per UE and not per radio bearer. For example, if a UE is receiving three radio bearer services, e.g., VoIP, FTP, and instant messaging, the UE is configured with one set of DRX parameters, rather than three sets. Furthermore, the UE is instructed to apply one DRX parameter, rather than one DRX parameter per radio bearer.

In general, a DRX parameter may include or relate to a number of DRX information, including the level/period indicating when a UE may go to sleep and for how long. A DRX cycle length, for example, is generally the time distance between the start positions of two consecutive active periods. An active period is the period during when a UE's transmitter and/or receiver is turned on, while a sleep period is the period during which a UE's transmitter and/or receiver is turned off, thereby saving power. Described in another way, the set of DRX parameters enables a UE to go to sleep and just be periodically awake or active to receive incoming data.

As mentioned, an adjustment or change to the DRX parameter being applied by a UE may be indicated or instructed via in-band signaling 646, 656 or L1/L2 signaling. Such DRX adjustment or change may be applied immediately after receipt of that in-band signaling or L1/L2 signaling, based on other conditions instructed by the eNodeB—e.g., delay parameters, or based on conditions defined by 3GPP. The RRC signaling of DRX parameters may be applied similarly to in-band or L1/L2 signaling.

In some embodiments, considering that in-band signaling 646, 656 is at Layer 2, in-band signaling thus may be adapted to provide DRX signaling that is typically transmitted and received faster than RRC signaling, thereby providing fast adjustments of the DRX parameter, particularly its period or duration. In some embodiments, in-band signaling 646, 656 may indicate the DRX parameter to apply from the set of DRX parameters configured in the UE. In-band signaling 646, 656 may also provide the actual value of the DRX parameter to be applied by the UE. Furthermore, in-band signaling may also indicate to the UE to apply the next longer DRX period, the next smaller DRX period, no DRX period at all—meaning continuous reception, or the same DRX period currently being applied. Thus, in-band signaling is adapted to lengthen or shorten the applied DRX period, to make no change to the currently applied DRX parameter, and to change the DRX mode to a continuous reception mode or vice versa. In-band signaling is typically performed via available channels being utilized by Layer 2 protocol stacks, without allocating additional channel(s) for such signaling.

The set of DRX parameters provided by RRC signaling may include one or more DRX parameters, e.g., one or more parameters related to varying length of DRX periods. As mentioned, a DRX parameter may include or indicate a number of information, such as a DRX duration, when to start a DRX period, and other information. DRX parameters related to periods, for example, may be based on fractions of time increased by a factor of two. Once the set of DRX parameters is received by the UE, the UE may store these one or more DRX parameters in an appropriate data store, such as in a memory chip.

The eNodeB 610 of FIG. 6 is shown transmitting, via RRC signaling 642, one set of DRX parameters 602 to UE 1 620. This set of DRX parameters may be an initial set or an updated set that was signaled by eNodeB 610 in response to a new bearer connection for that UE1. RRC signaling 642 may also include the DRX parameter to be applied by the UE1 620 as instructed by the eNodeB 610. The set of DRX parameters 602, the DRX parameter to be applied and/or other DRX information may be configured in the UE1, by storing such information in a UE 1 data store.

For illustrative purposes, let us assume that eNodeB 610, at a later time, has determined that the DRX parameter being applied by UE1 620 has to be adjusted. Such adjustment instructions may be transmitted by the eNodeB 610, via in-band signaling 646, for example, via a MAC PDU 648 or any other Layer 2 data unit. Similarly, the eNodeB 610 may adjust the DRX parameter being applied by UE2 630, by in-band signaling 656, e.g., via a MAC PDU 658. The MAC PDU 658 may indicate the DRX parameter to be applied from the set of DRX parameters 660 configured in UE2 630.

In some embodiments of the invention, in-band signaling is carried by Layer 2 PDU as a header, e.g., as MAC PDU header, as payload, e.g., MAC PDU payload, or as both header and payload. In some embodiments, the exemplary system may be designed such that in-band signaling is carried, for example, by the MAC PDU every time a MAC PDU is transmitted from the eNodeB 610 to the UE 620, 630. In other embodiments, the system may be designed such that in-band signaling is carried only, e.g., by the MAC PDU, only when an adjustment has to be performed at the UE side or based on other conditions, e.g., periodically.

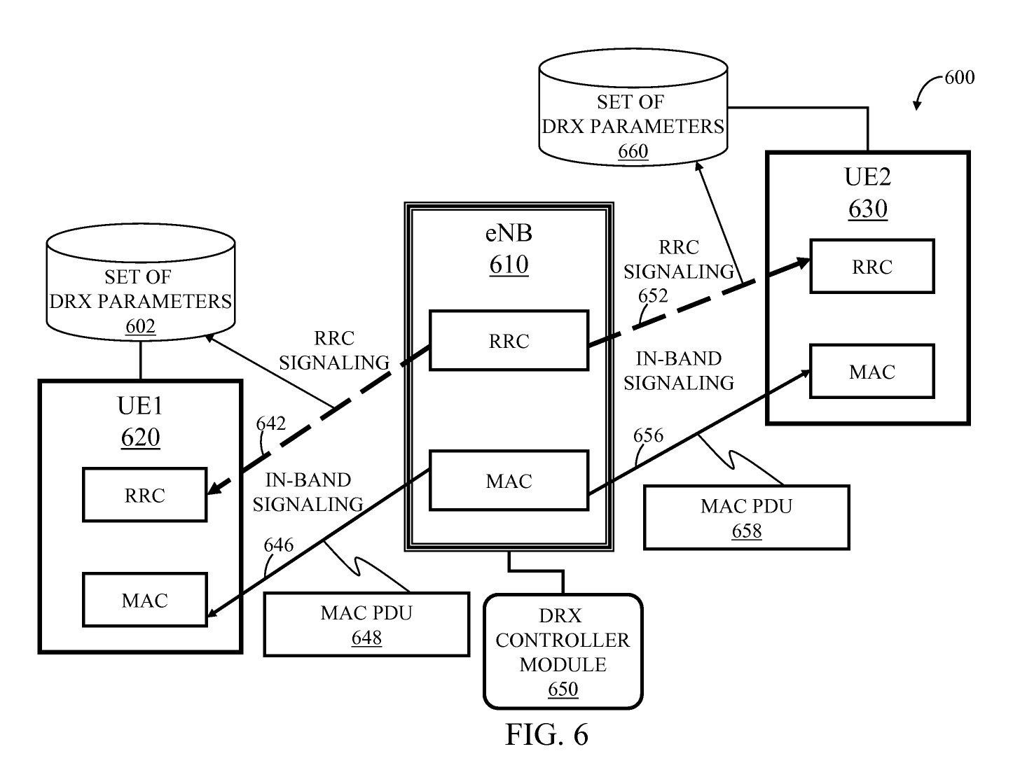

FIG. 7 is a diagram 700 of an exemplary field 702 that may be placed in a MAC PDU, either in the header area/section, payload area/section, or both, so as to perform the in-band signaling process of the present invention. As mentioned above, such in-band signaling may be performed via other Layer 2 data units, rather than MAC PDUs.

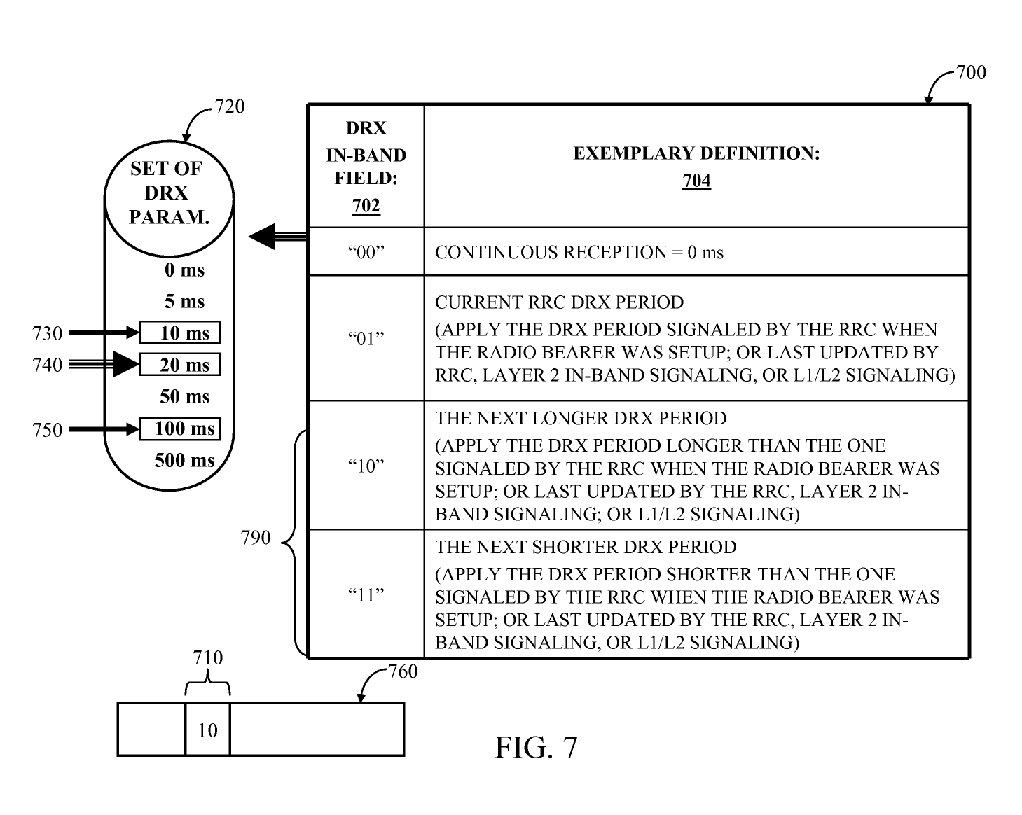

The exemplary DRX in-band field 702 of the present invention provides for a two-bit indication, which may be associated with up to four values. In this example, the set of DRX parameters being adjusted is related to the DRX period or duration. In other embodiments, the set of DRX parameters being adjusted may be related to when the DRX period is to start. In other embodiments, the set of DRX parameters may be related to a combination of information, such as to the DRX period and to when such a DRX period is to start. The use of the DRX period in the set of DRX parameters, in FIGS. 7 and 8, is for exemplification purposes. The exemplified embodiments of the present invention may be modified, such that the set of DRX parameters to be adjusted by Layer 2 in-band signaling of the present invention is related to when a DRX period is to start. If the set of DRX parameters is related to when a DRX period is to start, the exemplary definitions, associated with the in-band fields 702, may also have to be modified. Furthermore, the use of two bits is for exemplification purposes.

In this exemplary embodiment, each value of the bits is associated with an exemplary definition 704, which may be applied to adjust or replace the current DRX period. The set of DRX parameters 720 is shown related to DRX periods. For example, “00” in the in-band field indicates to the UE to apply continuous reception, while “01” indicates to the UE to apply the last DRX parameter signaled via RRC signaling, “10” indicates to the UE to apply the next longer DRX parameter, and “11” indicates to the UE to apply the next shorter DRX parameter.

To illustrate, an exemplary UE is configured with a UE-specific set of DRX parameters 720, which may have been received from and negotiated with an eNodeB via RRC signaling. The UE, in this example, currently applies a current DRX parameter period of 10 ms 730. Let us further assume that at a previous RRC signaling, the UE is instructed to use 100 ms as a current RRC DRX period 750. The current DRX parameter of 10 ms 730 is due to an in-band signaling previously received by the UE after the RRC signaling. A new in-band signaling 760, as a MAC PDU, is received by the UE and which contains an indicator, i.e., an in-band field 710, which may be in the header, payload, or both areas, with a value of “10.” The value of “10” is associated with the next longer DRX period. The receipt of this in-band signaling by the UE thus instructs the UE to apply the next longer DRX period, which in this case is 20 ms 740. After receipt of this in-band signaling 760, the UE thus adjusts its current DRX parameter and applies this new 20 ms DRX period 740.

In some other embodiments, the in-band signaling process only provides for one bit, and thus may indicate two values. In this example, the in-band signaling may instruct the UE to switch to a next longer DRX period—e.g., as a “0” bit value, or to the next shorter DRX period—e.g., with a “1” bit value 790. In some embodiments, more than two bits may also be used.

Although the example herein is described wherein changes to the DRX period to apply are communicated via in-band signaling, L1/L2 signaling and/or RRC signaling may also be applied and still be in the scope of the present invention.

FIG. 8 is another diagram 800 of another embodiment of the in-band signaling of the present invention, but where the exemplary DRX in-band field 802 is used to indicate or represent possible DRX values 804, particularly DRX periods. In this example, the in-band field contains 4 bits, from “0000” to “1111,” indicating defined or representative DRX periods. The association of DRX in-band field 802 and its associated exemplary definition 804 is exemplified in the table 810. For illustrative purposes, let us assume that the UE is configured with a set of DRX parameters with 16 possible DRX periods 820. The UE receives an RLC PDU 860 as an in-band signaling, which contains a “0100” 850 for its DRX in-band field. After receipt of this in-band signaling by the UE, the UE adjusts its current DRX period to 50 ms 840, considering that “0100” indicates 50 ms.

In other embodiments, the UE may not have stored the exemplary set of DRX parameters 820. The UE, however, may be coded or configured, e.g., via a set of program instructions or software applications, to know that, for example, “0100” is associated with 50 ms, and “0101” is associated with 100 ms.

Although the exemplary embodiments in FIG. 7 and FIG. 8 illustrate exemplary in-band fields and their exemplary definitions, i.e., bits definition, other bits definition may be varied and yet still be in the scope of the present invention. For example, the number of bits and/or definitions may be changed and yet still be in the scope of the present invention. Furthermore, the set of DRX parameters may be related to a different DRX information, other than the DRX period.

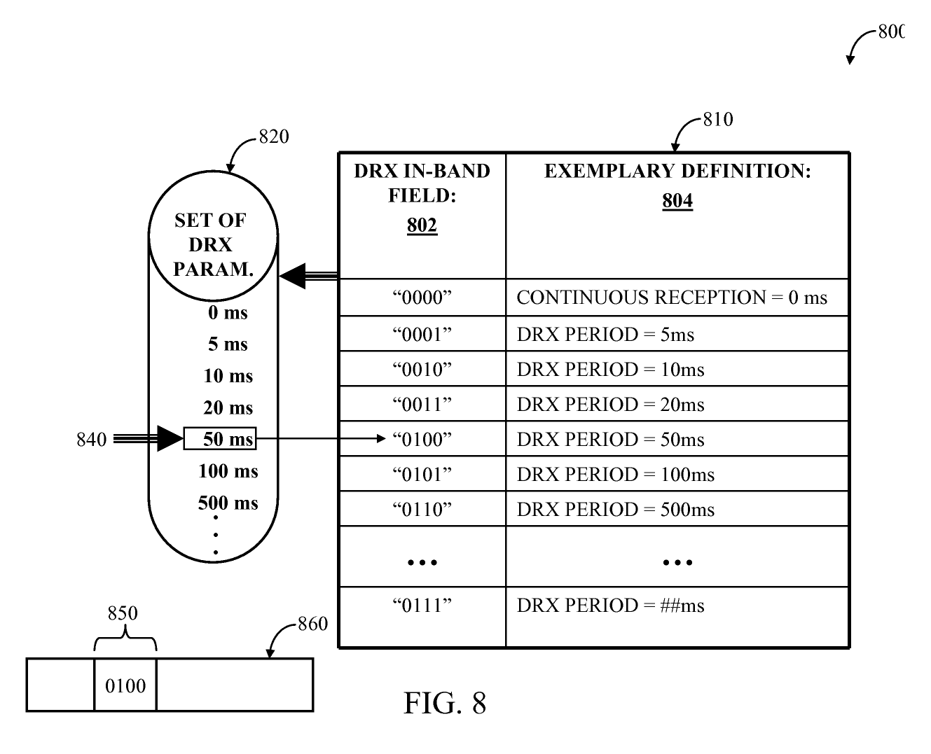

FIG. 9 is a chart of an exemplary flexible DRX mechanism 900 according to an embodiment of the invention. In this embodiment, in-band signaling and RRC signaling are applied. The explicit DRX signaling 902, 904, 906, 908, 910, 912, 918 for fast and direct DRX adjustment is via in-band signaling carried by Layer 2, particularly by the MAC PDU, which may be in the MAC header. Although not shown, other in-band signaling mechanisms, such as an RLC PDU, which may in the header, may also be applied. In this exemplary graph, the DRX parameter or level to be applied is based on a 2-bit embodiment.

The DRX period/level to be applied via this 2-bit embodiment may indicate:
Case 1—“00”: DRX period=0, which means continuous reception;
Case 2—“01”: DRX period=current RRC DRX period, use the DRX period signaled by the RRC when the radio bearer was setup, or last updated by RRC or by in-band signaling;
Case 3—“10”: DRX period=the next longer DRX period, use the DRX period longer than the one signaled by RRC when the radio bearer was setup, or last updated by RRC or L2 in-band signaling;
Case 4—“11”: DRX period=the next shorter DRX period, use the DRX period shorter than the one signaled by RRC when the radio bearer was setup, or last updated by RRC or L2 in-band signaling.
   In this exemplary embodiment, the eNodeB and the UEs are aware that signaling is via RRC and Layer 2 in-band signaling.

Using two bits, we may indicate Case 1 by “00,” Case 2 by “01,” Case 3 by “10,” and Case 4 by “11.” In another embodiment, we may use L1/L2 control channel to carry such explicit DRX signaling.

By applying the embodiments of the present invention, FIG. 9 thus shows that the DRX control mechanism of the present invention is more flexible and efficient than the two mechanisms illustrated in FIGS. 1 and 2. For example, when a “Data scheduled” event occurs (e.g., 902 or 910), the DRX level may not be forced to the “continuous” level. Instead, the eNodeB may inform and control the UE to go to a suitable and desired DRX level, if needed 904, 912. Furthermore, the UE may be controlled or is adapted to go directly to the desired DRX level 914, without having to wait for timer expirations and/or applying intermediate DRX level(s). For example, an explicit Layer 2 in-band signaling via MAC PDU is received by the UE 902 instructing the UE to go to the DRX n−1 Level 932, as shown. Through this explicit in-band signaling, the UE directly transitions to the DRX n−1 Level 932 from the DRX n Level 930, as shown. The UE thus, when explicitly signaled, may go directly or directly apply a long DRX level/period without having to apply one or more intermediate DRX level(s). The embodiments of the present invention thus provide a UE better power-saving performance. Looking at the graph, the other events 904, 912, 916, 918 may also be considered as “Data scheduled” events. As shown in FIG. 9, RRC signaling 914, 916 may also be used to change the UE-specific DRX level set.

As shown in FIG. 9, the embodiments of the present invention enable a flexible DRX control which may use explicit signaling to trigger the transition from continuous reception level (no DRX) to a short DRX level (e.g., DRX n 930) 906, and may also use either explicit signaling or implicit timer-based (or rule-based) mechanism 908 to further extend a DRX level to a longer DRX level. Such rule-based mechanism, including rules to apply, may be defined within the UE, for example. Such rules may be based on table look-ups or programmatic application of rules, or within means known to those of ordinary skill in the art.

Implicit signaling, which may be based on timers and/or rules, typically occurs after receipt of an explicit signaling indicating which DRX level to apply. Furthermore, the implicit signaling of the present invention typically applies when the DRX level currently being applied is not the continuous reception DRX level. In this exemplary graph 900, assuming that an implicit timer expiration 908 occurs rather than an explicit in-band signaling, the DRX level is adjusted so that the next longer DRX is applied, i.e., the UE transitions from DRX n 930 to DRX n+1 936. In this exemplary graph, the continuous reception level is shortest in duration (0 ms) and DRX m 940 indicates the longest DRX duration. Thus, DRX n+1 936 has a longer DRX period than DRX n 930. One of ordinary skill in the art will appreciate that the UE-specific set of DRX parameters may contain various numbers of DRX levels, with varying levels or periods.

In another embodiment, we may use L1/L2 signaling channel to carry such DRX information indicating which DRX level is to be used. Variations and changes to the current L1/L2 signaling channel may possibly have to be performed to indicate “which DRX period parameter is to be used” in L1/L2 signaling channel. In some embodiments, a system may use one, more, or all of the available signaling mechanisms, i.e., RRC signaling, Layer 2 in-band signaling, e.g., MAC PDU and/or RLC PDU, and/or L1/L2 control channel.

The target usage of the embodiments of the present invention is 3GPP LTE systems. However, the embodiments may apply to other advanced communication systems which need more efficient DRX control to save power consumption and in the same time to ensure good throughput performance.

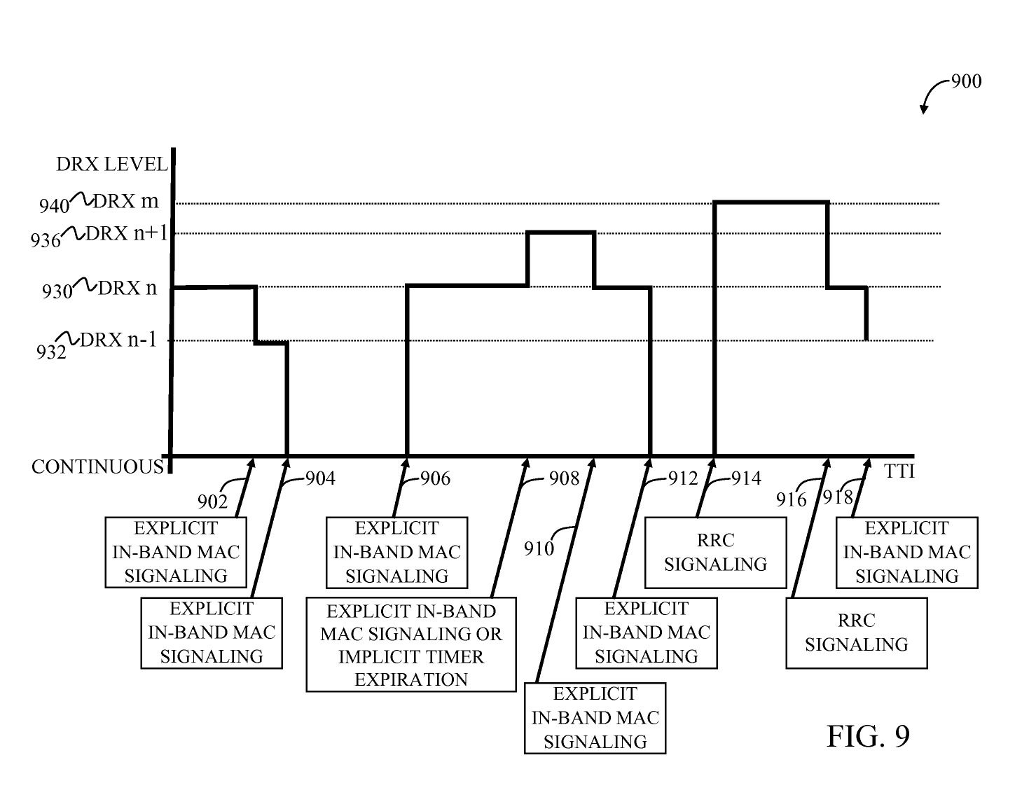

FIG. 10 is a high-level block diagram of an exemplary eNodeB 1010, according to an embodiment of the invention. In general, the eNodeB 1010 includes a DRX controller and negotiator module 1050 adapted to determine and negotiate the set of DRX parameters and the current DRX parameter or the DRX parameter to be applied by the UE. The DRX controller and negotiator module 1050 is thus adapted to provide the UE with a UE-specific set of DRX parameters. Furthermore, the DRX controller module 1050 is adapted to signal DRX instructions via Layer 2 in-band signaling, RRC signaling, and/or L1/L2 signaling. The DRX controller and negotiator module 1050 may also be adapted to perform the eNodeB-side processes, described herein. The eNodeB 1010 may also include a radio communication interface 1060 adapted to enable the eNodeB 1010 to communicate with the UEs it manages. Other modules may also be added but not shown. The DRX controller and negotiator module 1050 and the communication interface 1060 may interface with each other, for example, via a shared memory, a data line, a bus, dedicated signal paths, or one or more channels 1002. Furthermore, these modules may be embodied in hardware, as a set of program instructions, e.g., software, or both, i.e., firmware. Other modules may also be included, not shown, which may depend on the functions being performed by the eNodeB 1010.

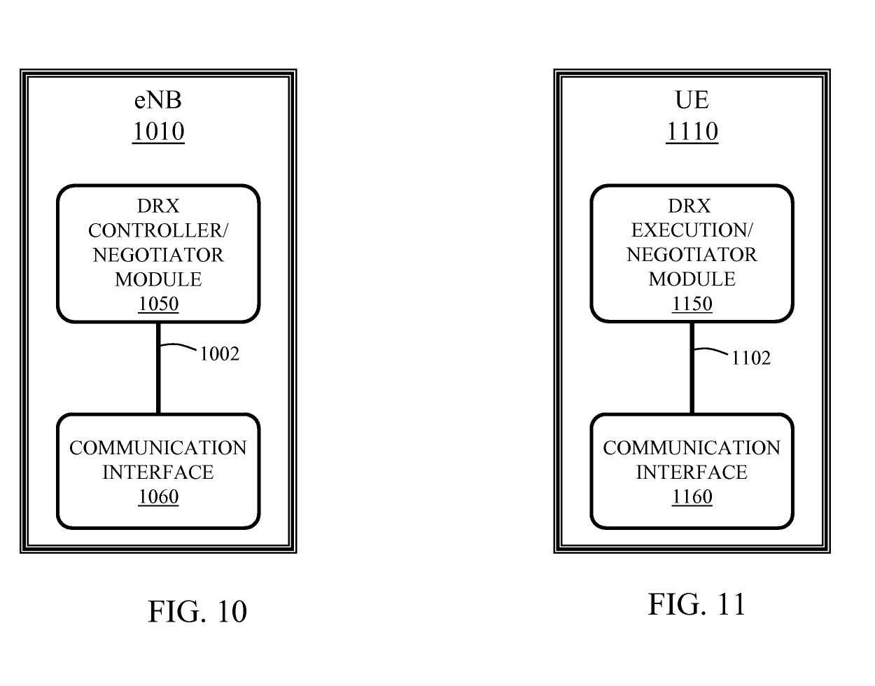

FIG. 11 is a high-level block diagram of an exemplary UE 1110, according to an embodiment of the invention. In general, the UE 1110 includes a DRX execution and negotiator module 1150 adapted to receive in-band signaling, L1/L2 signaling, and/or RRC signaling, and accordingly adapted to follow the instructions as signaled via these signals. The DRX execution and negotiator module 1150 may also be adapted to perform the UE-side processes, described herein, including specifying and/or negotiating the UE-specific set of DRX parameters to be applied by the UE. Furthermore, the DRX execution/negotiator module may also be configured to determine the set of DRX parameters to negotiate with the eNodeB, based on its UE-specific conditions, such as, but not limited to, UE requirements, applications received, and/or functions of the UE. Algorithms, table lookup, built-in configuration information, and other means, for the UE to determine its UE-specific set of DRX parameters to negotiate with the eNodeB may also included in the UE 1110. The UE 1110 may also include a radio communication interface 1160 adapted to enable the UE 1110 to communicate with an eNodeB. Other modules may also be added but not shown, which may depend on the processes and functions of the UE. The DRX execution module 1150 and the communication interface 1160 may interface with each other, for example, via a shared memory, a data line, a bus, dedicated signal paths, or one or more channels 1102. Furthermore, these modules may be embodied in hardware, as a set of program instructions, e.g., software, or both, i.e., firmware. Other modules may also be included, not shown, which may depend on the functions being performed by the UE 1110. The modules described in FIGS. 10 and 11 may be combined or further subdivided and yet still be in the scope of the present invention.

Although the embodiments of the present invention discussed herein are exemplified using E-UTRA, E-UTRAN, and 3GPP LTE, the features of the present invention may be applied to other systems and networks that may require fast adjustment of DRX parameters to save power consumption and/or provide good throughput performance. For example, the embodiments of the present invention may also be applied on other radio systems, including, but not limited to WLAN, IEEE 802.16, IEEE 802.20 networks.

Embodiments of the present invention may be used in conjunction with networks, systems, and devices that may employ DRX parameters. Although this invention has been disclosed in the context of certain embodiments and examples, it will be understood by those of ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. The embodiments of the present invention may be embodied in a set of program instructions, e.g., software, hardware, or both—i.e., firmware. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

I claim:

1. A method of managing a user equipment (UE) by an eNodeB, the method comprising the steps of:
transmitting, via a Layer 3 signaling, by said UE to said eNodeB, a set of one or more DRX parameters;
defining, by said eNodeB, a UE-specific set of discontinuous reception (DRX) parameters based on said received set of one of more DRX parameters from said UE;
receiving by said UE said UE-specific set of DRX parameters;
transmitting, by said eNodeB to said UE, a current DRX indicator associated with a DRX parameter to apply from said UE-specific set of DRX parameters; and
directly applying by said UE said indicated DRX parameter.

2. The method of claim 1, wherein said set of DRX parameters is related to DRX periods.

3. The method of claim 1, said Layer 3 signaling is via a radio resource control (RRC) protocol stack conforming to the Evolved Universal Terrestrial Radio Access (E-UTRA) and Evolved Universal Terrestrial Radio Access Network (E-UTRAN) specification.

4. The method of claim 1 wherein said current DRX indicator is represented by 2 bits.

5. The method of claim 4, wherein said 2 bits indicate to said UE at least one of the following:
apply continuous reception;
apply the next longer DRX period;
apply the next shorter DRX period;
apply the DRX period received via at least one of the following—Layer 3 signaling, Layer 2 in-band signaling, L1/L2 signaling.

6. The method of claim 1, wherein said step of receiving by said UE said UE-specific set of DRX parameters is received via at least one of the following—Layer 3 signaling, Layer 2 in-band signaling, L1/L2 signaling.

7. The method of claim 6, wherein said Layer 2 in-band signaling is communicated via a Layer 2 protocol data unit (PDU), and wherein said Layer 2 PDU is at least one of the following: a Medium Access Control (MAC), a radio link control (RLC) PDU, a Packet Data Convergence Protocol (PDCP) PDU.

8. The method of claim 6, wherein said Layer 3 signaling is via a radio resource control (RRC) protocol stack conforming to the Evolved Universal Terrestrial Radio Access (E-UTRA) and Evolved Universal Terrestrial Radio Access Network (E-UTRAN) specification.

9. The method of claim 7, wherein said current DRX indicator is stored in a payload section of said Layer 2 PDU.

10. The method of claim 1, wherein said step of receiving by said UE of said Layer 2 PDU is via a radio network.

11. The method of claim 1, wherein said UE-specific set of DRX parameters comprises a continuous reception DRX parameter, and wherein said step of transmitting, by said eNodeB to said UE, said current DRX indicator is an explicit signaling indicating to said UE to transition directly from said continuous reception DRX parameter to said indicated DRX parameter, based on said current DRX indicator.

12. The method of claim 11, further comprising the step of:
directly applying by said UE another DRX parameter from said UE-specific set of DRX parameters, based on at least one of the following implicit conditions:
expiration of at least one timer, rules configured within said UE;
wherein said another DRX parameter is not said continuous reception DRX parameter, and said another DRX parameter has a longer DRX period than said indicated DRX parameter.

13. A system comprising:
an Evolved Universal Terrestrial Radio Access Network (E-UTRAN) device comprising:
a DRX controller and negotiator module adapted to:
receive, via a Layer 3 signaling, from a user equipment (UE) a set of one or more DRX parameters;
define a UE-specific set of DRX parameters based on said received set of one of more DRX parameters from said UE;
transmit said UE-specific set of DRX parameters; and
transmit a current DRX indicator associated with a DRX parameter to apply from said UE-specific set of DRX parameters; and
a communication interface module adapted to:
enable communication between said UE and the E-UTRAN device; and
said UE operably connected to said eNodeB, said UE comprising:
a DRX execution and negotiator module adapted to:
transmit, via said Layer 3 signaling, said set of one or more DRX parameters;
receive said UE-specific set of DRX parameters;
receive said current DRX indicator associated with said DRX parameter to apply from said UE-specific set of DRX parameters; and
directly apply said DRX parameter for discontinuous reception; and
a communication interface module adapted to:
enable communication between said UE and the E-UTRAN device.

14. The system of claim 13 wherein said communication interface of the E-UTRAN device and said communication interface of said UE are both radio communication interfaces.

15. The system of claim 13, wherein said current DRX indicator indicates at least one of the following:
apply continuous reception;
apply the next longer DRX period;
apply the next shorter DRX period;
apply the DRX period received via at least one of the following—Layer 3 signaling, Layer 2 in-band signaling, L1/L2 signaling.

16. The system of claim 13, wherein said set of DRX parameters is related to DRX periods.

17. The system of claim 13, wherein said Layer 3 signaling is via a radio resource control (RRC) protocol stack conforming to the Evolved Universal Terrestrial Radio Access (E-UTRA) and Evolved Universal Terrestrial Radio Access Network (E-UTRAN) specification.

18. The system of claim 13, wherein said DRX execution and negotiator module is further adapted to receive said current DRX indicator via at least one of the following—Layer 3 signaling, Layer 2 in-band signaling, L1/L2 signaling.

19. The system of claim 18, wherein said Layer 2 in-band signaling is communicated via a Layer 2 protocol data unit, and wherein said Layer 2 PDU is at least one of the following: a Medium Access Control (MAC), a radio link control (RLC) PDU, a Packet Data Convergence Protocol (PDCP) PDU.

20. The system of claim 19, wherein said current DRX indicator is stored in a header section of said Layer 2 PDU.

21. The system of claim 13, further comprising:
a radio network conforming to an Evolved Universal Terrestrial Radio Access Network (E-UTRAN) specification with which the E-UTRAN device and said UE communicate with each other.

22. The system of claim 13 wherein the E-UTRAN device is an eNodeB.

23. An Evolved Universal Terrestrial Radio Access Network (E-UTRAN) device comprising:
a discontinuous reception (DRX) controller and negotiator module adapted to:
receive, via a Layer 3 signaling, from a user equipment (UE) a set of one or more DRX parameters;
define a UE-specific set of DRX parameters based on said received set of one of more DRX parameters from said UE;
transmit said UE-specific set of DRX parameters; and
transmit a current DRX indicator associated with a DRX parameter to apply from said UE-specific set of DRX parameters; and
a communication interface module adapted to:
enable communication between said UE and the E-UTRAN device.

24. The device of claim 22 wherein the E-UTRAN device is an eNodeB.

25. A method of discontinuous reception (DRX) processing at a user equipment (UE), the method comprising the steps of:
receiving, by said UE, a UE-specific set of DRX parameters;
receiving, by said UE, at least one explicit signaling to trigger transition of said UE from a continuous reception DRX level to a first DRX level from said UE-specific set of DRX parameters, wherein said first DRX level has a longer period than said continuous reception DRX level;
directly applying, by said UE, said first DRX level;
expiring of a timer; and
directly applying, by said UE, a second DRX level from said UE-specific set of DRX parameters, wherein said second DRX level has a longer period than said first DRX level.
